(19) United States
(12) Patent Application Publication
(10) Pub. No.: US 2013/0262914 A1
(43) Pub. Date: Oct. 3, 2013

(54) CLOUD SYSTEM AND METHOD FOR MONITORING AND HANDLING ABNORMAL STATES OF PHYSICAL MACHINE IN THE CLOUD SYSTEM

(71) Applicant: DELTA ELECTRONICS, INC., Taoyuan County (TW)

(72) Inventors: Tze-Chern MAO, Taoyuan County (TW); Wen-Min HUANG, Taoyuan County (TW); Ping-Hui HSU, Taoyuan County (TW)

(73) Assignee: DELTA ELECTRONICS, INC., Taoyuan County (TW)

(21) Appl. No.: 13/743,933

(22) Filed: Jan. 17, 2013

(30) Foreign Application Priority Data
Mar. 27, 2012 (CN) 201210084484.3

(51) Int. Cl. G06F 11/07

(52) U.S. Cl. CPC G06F 11/0709
USPC 714/4.2

(57) ABSTRACT

A cloud system and a method for monitoring and handling abnormal states of physical machines in the cloud system are disclosed. Each physical machine of the cloud system respectively executes a daemon program for monitoring operation states of the physical machine and providing the operation states to a management terminal in the cloud system. When the management terminal determines that any physical machine is having abnormal operation states, the management terminal provides a control instruction to the cabinet of the physical machine having abnormal operation states. The physical machine having abnormal operation states is compulsorily ejected from the cabinet. Thus, it is convenient to the administrator when replacing the physical machine having abnormal operation states onsite by shortening the time looking for the faulted physical machine.

This application is based on and claims the benefit of China Application No. 201210084484.3 filed Mar. 27, 2012 the entire disclosure of which is incorporated by reference herein.

### BACKGROUND OF THE INVENTION

1. Field of the Invention

The present invention relates to a cloud system, in particular relates to a cloud system and a method for monitoring operation states of a physical machine, and compulsorily ejecting a physical machine from a cabinet immediately when the abnormal states occur during operation. 2. Description of Related Art

In recent years, as the semiconductor industry develops rapidly, the capabilities of a computer are growing more and more powerful. As the internet becomes more popular, cloud systems which provide servers at the service end for replacing computers at the client end is regarded as the future trend of computer technologies.

FIG. 1 is a schematic diagram of a cloud computing data center according to the related art. Generally speaking, a powerful cloud system computing center comprises tens of thousands of physical machines 12, these physical machines 12 provide various computing services to client ends. Though each physical machine 12 is used for executing various tasks depending on the requirements of client ends, these physical machines 12 in the cloud computing data center 1 have identical exterior and this makes it difficult to identify directly the respective roles of these physical machines 12 (such as working as a computing server or a storage server) from the exterior of these physical machines 12 by the administrators.

As mentioned above, when one of the physical machine 12 in the cloud computing data center 1 is damaged and expected to be replaced, it is difficult to an administrator to correctly identify the damaged physical machine 12 among a great many of physical machines 12. Accordingly, a system for administrating a cloud computing data center 1 is provided in the market, wherein a physical machine 12 is damaged, the administrator is automatically informed of the floor and location of the computing data center 1 where the damaged physical machine 12 is located, and further informed of the location of the cabinet in the computing data center 1 where the damaged floor physical machine 12 is located. Thus, the administrator is allowed to look for the damaged physical machine 12 onsite according to the location data and replace the damaged physical machine 12.

As mentioned previously, each physical machine 12 has identical exterior. If there are tens or hundreds of cabinet 11 in a computing data center 1, also each cabinet 11 has tens or hundreds of physical machines 12, it is still a difficult task to promptly identify exact location of the damaged physical machine 12 to the administrator according to the location data mentioned above. Not only the required time for replacing a damaged physical machine 12 is long, also the miss operation of replacing the damaged physical machine 12 may occur and lead to irreparable errors.

It is desired to offer innovative technologies to provide exact location data to administrators when a physical machine 12 in the cloud computing data center 1 is expected to be replaced. Not only the exact location data is provided to the administrators, the physical machine 12 expected to be replaced is directly ejected from the cabinet 11. When an administrator arrives on the computing data center 1, the physical machine 12 can be quickly identified and replaced and miss operation of replacing the physical machine 12 is avoided.

### SUMMARY OF THE INVENTION

The objective of the present invention is to provide a cloud system and a method for monitoring and handling abnormal states of physical machines in the cloud system. Administrators are allowed to monitor operation states of a plurality of physical machines in a cloud computing data center via a management terminal, and compulsorily ejecting the physical machine having abnormal operation states from the cabinet.

In order to achieve the above, each physical machine of the cloud system respectively executes a daemon program. The daemon program monitors the operation states of physical machines, and provides the operation states to a management terminal of the cloud system. When the management terminal determines that any physical machine is having abnormal operation states, the management terminal provides a control instruction to the cabinet of the physical machine having abnormal operation states. The physical machine having abnormal operation states is compulsorily ejected from the cabinet.

Compare with the related art, the advantage of the present invention is the daemon program executed in each physical machine continuously to monitor each number data of each physical machine, and further determines the operation states of physical machines. Administrators remotely control the management terminal, and receive the operation states of all physical machines in the cloud computing data center from the user interface of the management terminal. When a physical machine having abnormal operation states is required to be replaced, the physical machine is compulsorily ejected from the cabinet. Thus, when administrators arrive on the cloud computing data center to replace the damaged physical machine, the physical machine having abnormal operation states physical machine is ejected from cabinet and easily identified. The typical miss operation due to the identical exterior of all physical machines in a computing data center is accordingly avoided.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a cloud computing data center according to the related art;

FIG. 2 is a monitoring and control flowchart of a preferred embodiment according to the present invention;

FIG. 3 is a system architecture diagram of a preferred embodiment according to the present invention.

FIG. 4 is a system block diagram of a preferred embodiment according to the present invention.

FIG. 5 is a monitoring flowchart of a preferred embodiment according to the present invention;

FIG. 6 is a compulsory ejecting flowchart of a preferred embodiment according to the present invention;

FIG. 7 is a system architecture diagram of a second preferred embodiment according to the present invention;

FIG. 8 is a system block diagram of a second preferred embodiment according to the present invention;

FIG. 9 is a monitoring flowchart of a second preferred embodiment according to the present invention;

FIG. 10 is a flowchart of compulsory ejecting of a second preferred embodiment according to the present invention;

FIG. 11 is a system block diagram of a third preferred embodiment according to the present invention;

FIG. 12A is a schematic diagram before the physical machine is ejected from the cabinet of a preferred embodiment according to the present invention; and

FIG. 12B is a schematic diagram is a schematic diagram after the physical machine is ejected from the cabinet of a preferred embodiment according to the present invention.

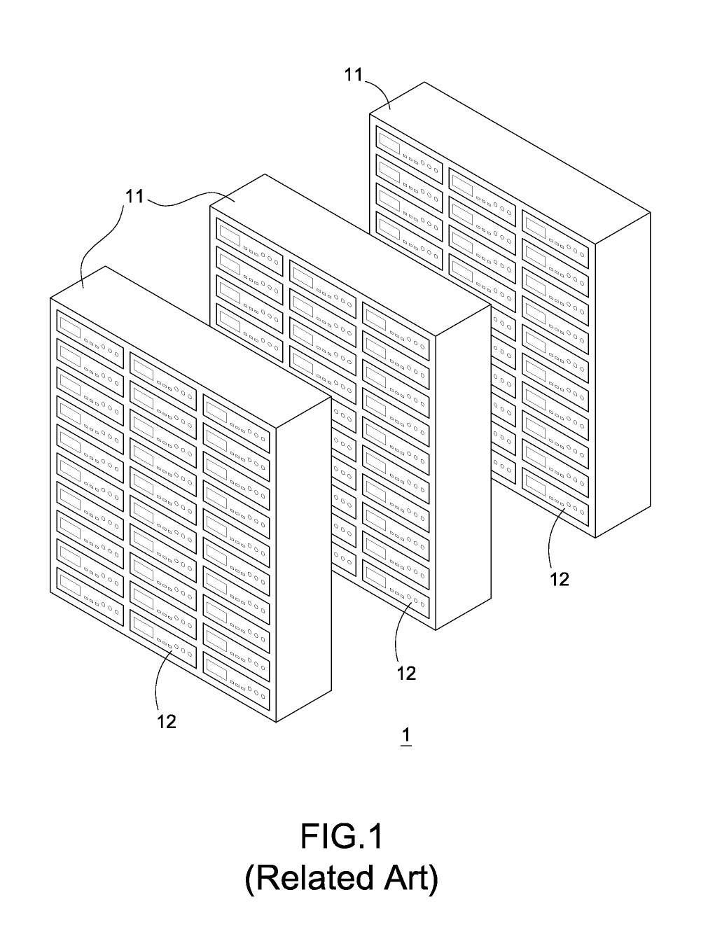

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

The present invention provides a cloud system and a method for monitoring and handling abnormal states of physical machines in the cloud system. The method for monitoring and handling abnormal states of physical machines in a cloud system is used in a management terminal of a cloud system (the management terminal 3 shown in FIG. 3) and a plurality of physical machines (the physical machine 22 shown in FIG. 3). When one of the physical machines 22 of the cloud system is required to be replaced, the management terminal 3 can either be operated or set to automatically control the cabinet where the damaged physical machine 22 is located (the cabinet 21 shown in FIG. 3) for compulsorily ejecting the physical machine 22 form the cabinet 21. Thus, administrators are allowed to quickly and precisely locating the physical machine 22 expected to be replaced onsite.

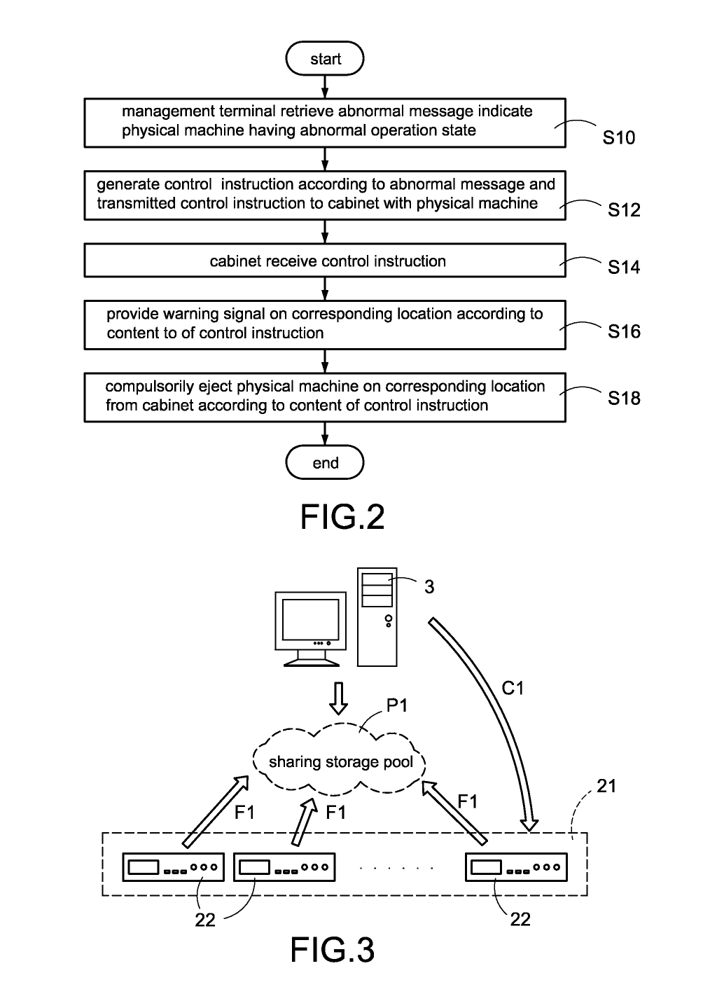

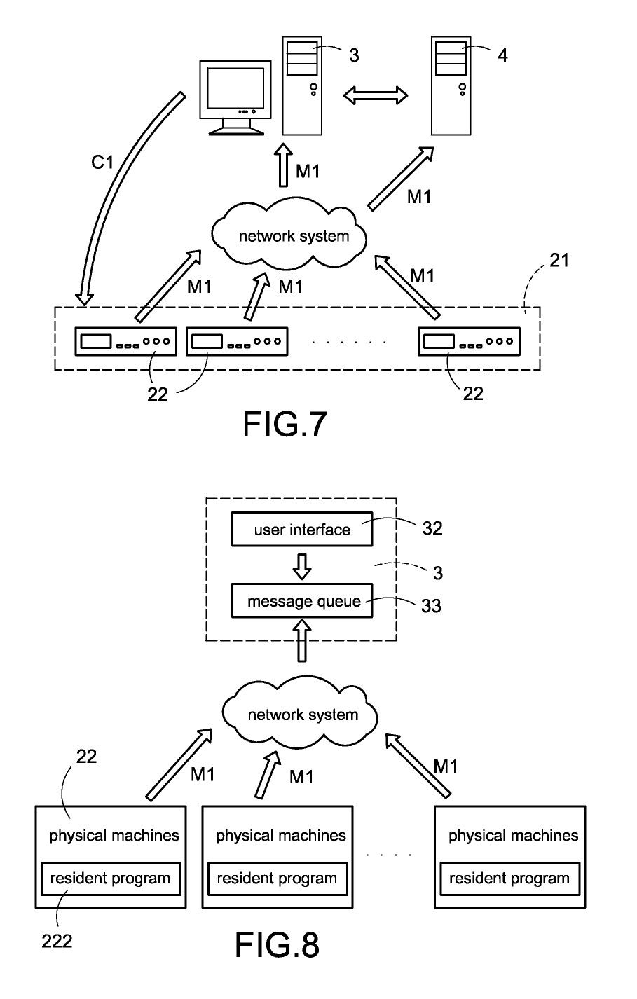

FIG. 2 is a monitoring and control flowchart of a preferred embodiment according to the present invention. First, the management terminal 3 retrieves an abnormal message (the abnormal message M1 shown in FIG. 7) indicating the physical machine 22 having abnormal operation states (step S10), wherein the management terminal 3 retrieves the abnormal message by various methods detailed in the following.

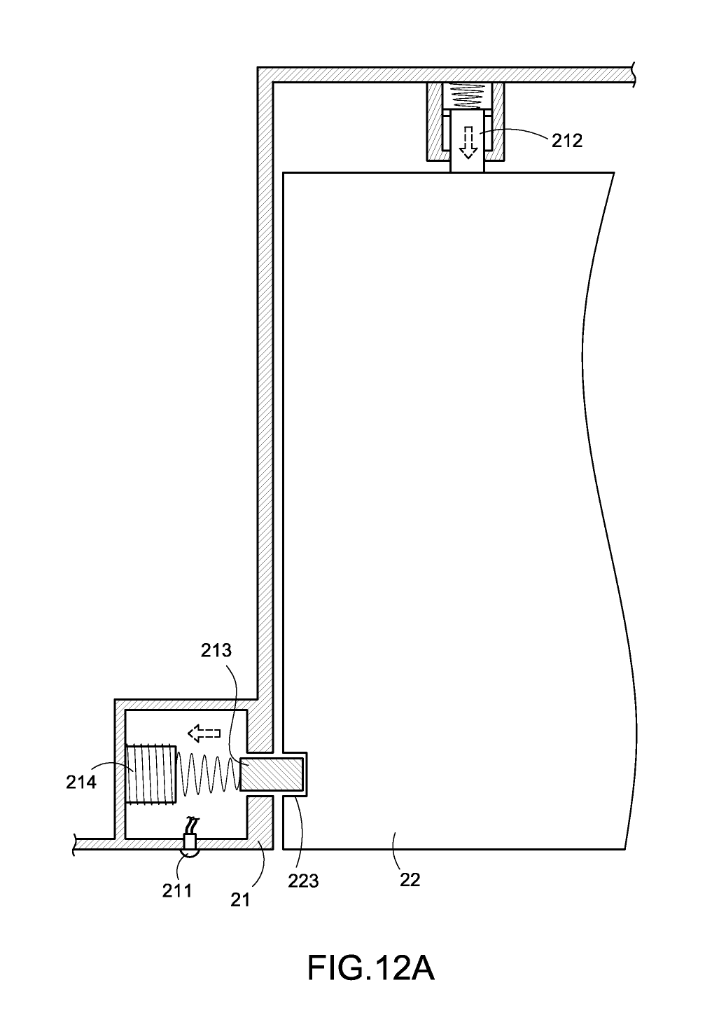

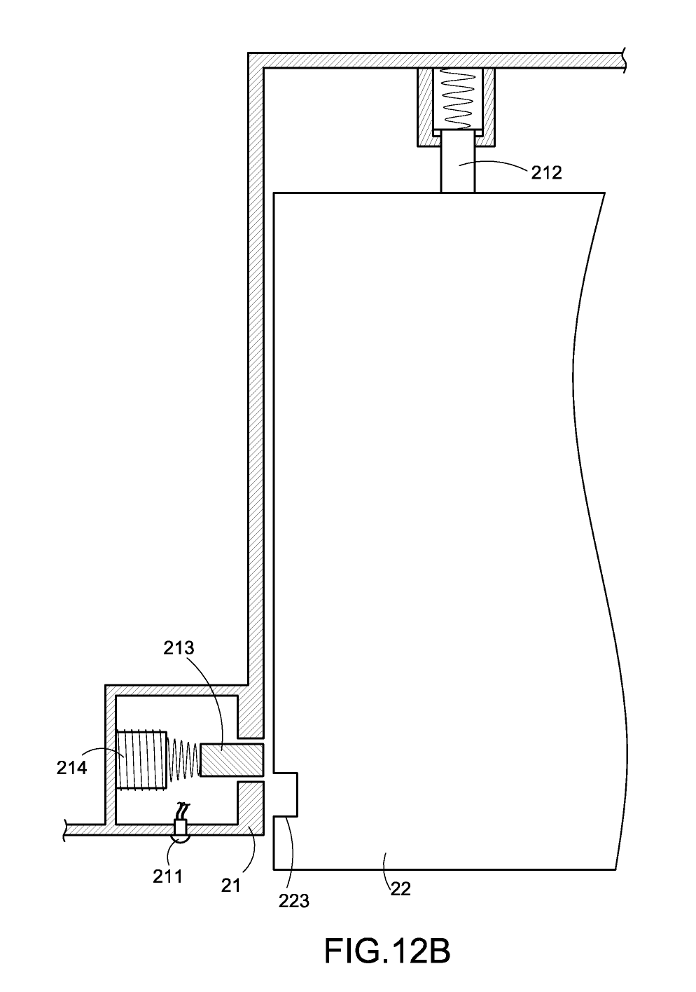

Next, the management terminal 3 generates a control instruction (the control instruction C1 shown in FIG. 3) according to the abnormal message M1, and the control instruction C1 is transmitted to the cabinet 21 with the physical machine 22 having abnormal operation states (step S12). The cabinet 21 receives the control instruction C1 (step S14), and provides a warning signal on the corresponding location according to the content of the control instruction C1 (step S16). In the embodiment, the cabinet 21 is respectively installed with at least one light emitting component (for example the light emitting diodes 211 as shown in FIG. 12A) on the assigned locations of the physical machines 22. In the step S16, the cabinet 21 provides warning signals via the light emitting component 211 on the corresponding locations (for example lighting the LED). Thus, when administrator arrive onsite, the physical machine 22 to be replaced can be easily identified with the light emitting component 211.

Lastly, the cabinet 1 compulsorily ejects the physical machine 22 on the corresponding location from the cabinet 21 according to the content of the control instruction C1 (step S18). Thus, when the administrators arrive, the ejected physical machine 22 from the cabinet 21 can be quickly identified and replaced. The objective of the present invention is to provide a method such that administrators are allowed to quickly and precisely identify the physical machine 22 expected to be replaced. As a result, given the step S16 and the step S18 both manage to achieve the above objective, the method does not require to include the step S16 and the step S18 at the same time, and is not limited thereto.

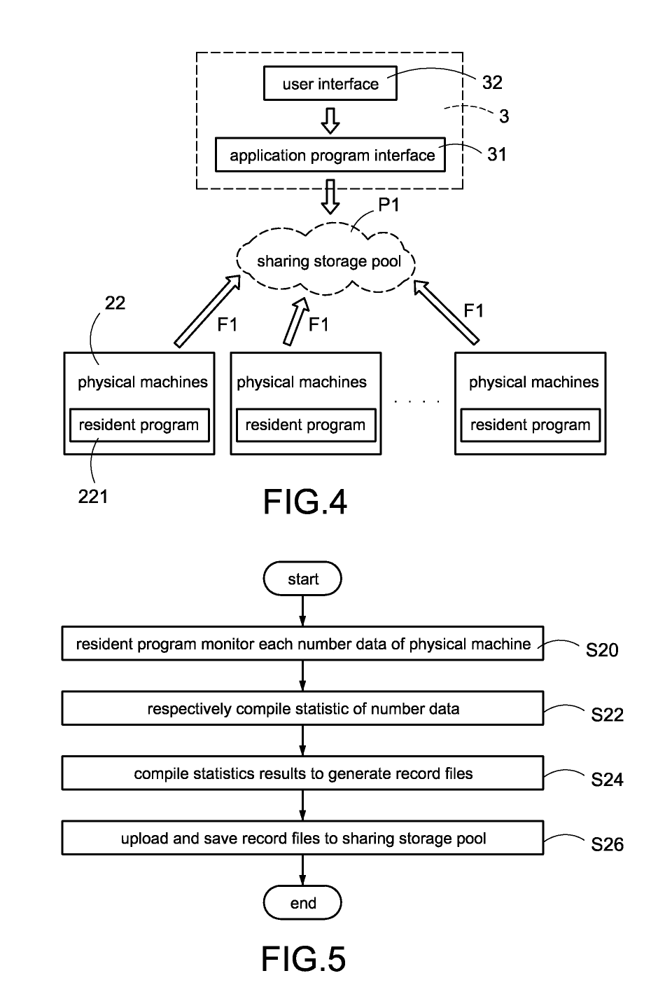

FIG. 3, FIG. 4 and FIG. 5 are a system architecture diagram, a system block diagram, and monitoring flowchart of a preferred embodiment according to the present invention. As mentioned above, a cloud system may include many computing data centers, and each computing data center has many cabinets 21. In the following embodiment, a cabinet 21 is used as an example to detail the method of the present invention, and many physical machines 22 are assigned to the cabinet 21, but is not limited thereto. As shown in the diagram, each the physical machine 22 executes a daemon program 221, the daemon program 221 is routinely executed, and continuously monitoring each number data of the physical machine 22 for further analyzing the operation states of the physical machines 22.

As shown in FIG. 5, firstly, the daemon program 221 monitors each number data of the physical machine 22 (step S20), and respectively compile statistics of these number data (step S22). Further, the daemon program 221 compiles statistics results to generate one or multiple record files F1 (step S24). Lastly, the physical machines 22 in the cabinet 21 respectively upload and save these record files F1 to a sharing storage pool P1 on the network via the internal daemon program 221 (step S26).

As shown in FIG. 4, the daemon program 221 monitors each number data of the physical machine 22, such as operation states of CPU, memory, hard drive and network traffic, temperature, voltage and fan speed etc., but are not limited thereto. In further details, the daemon program 221 compiles statistics of the above number data and generates a .rrd file to be checked by the management terminal 3. In the embodiment, the daemon program 221 generates a cpu.rrd file based on CPU states, and generates a memory.rrd file based on memory states, generates a disk.rrd file based on hard drive states, generates a network.rrd file based on network traffic, generates a temperature.rrd file based on temperature states, generates on voltage.rrd file based on voltage states, and generates on fanspped.rrd file based on fan speed states. Nonetheless, the above describes embodiments of the present invention and the scope of the invention is not limited thereto.

The management terminal 3 has a monitor application program interface (API) 31 and a user interface 32. The management terminal 3 retrieves these record files F1 from the sharing storage pool P1 via the monitoring API 31, and display operation states of these physical machines 22 via the user interface 32 whereby administrators can check and analyze.

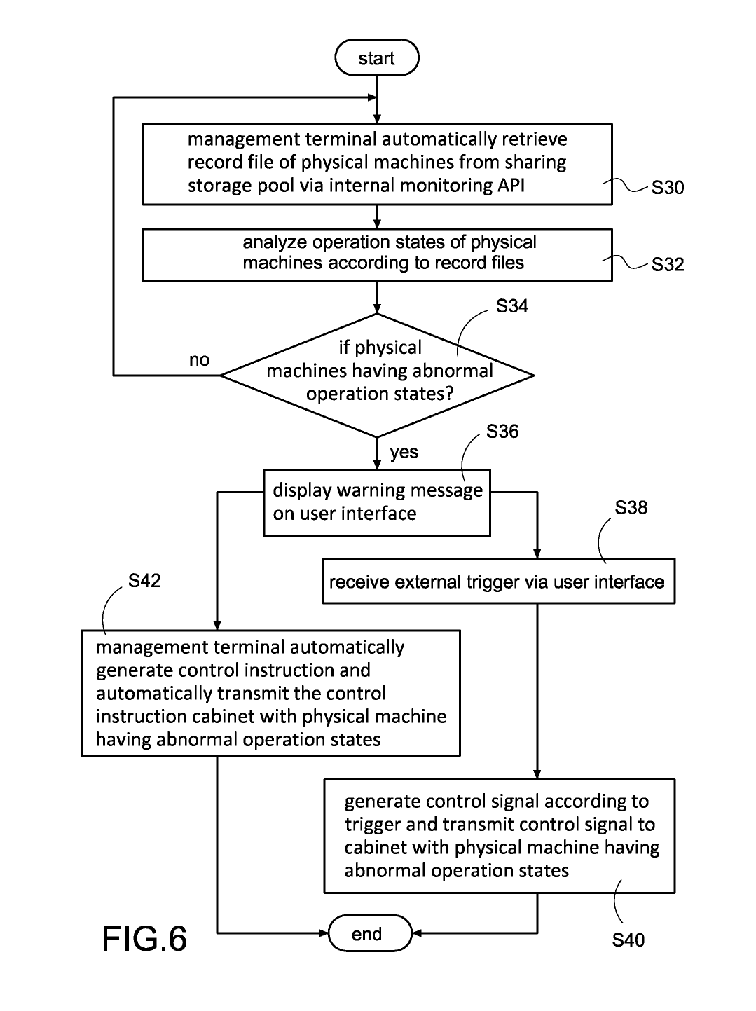

FIG. 6 is a compulsory ejecting flowchart of a preferred embodiment according to the present invention. Firstly, the management terminal 3 automatically retrieves the record files F1 of all physical machines 22 from the sharing storage pool P1 via the internal monitoring API 31 (step S30). Next, the operation states of the physical machines 22 are analyzed according to these record files F1 (step S32). The monitoring API 31 analyze if these physical machines 22 have abnormal operation states (step S34). If none of the physical machines 22 have abnormal operation states, the method move back to the step S30 to retrieving updated record files Fl again from the sharing storage pool P1. If the monitoring API 31 determines that any physical machine 22 has abnormal operation states, a warning message is displayed on the user interface 32 (step S36), to keep administrators informed.

In the embodiment, the monitoring API 31 generates an abnormal events message or an abnormal state message to inform the administrators according to the analyzed results of the step S34. When the physical machine 22 has abnormal events, such as CPU usage is higher than 70%, the network traffic is higher than 10 M per second or the temperature is higher than 70 degree ° C., abnormal events message are generated accordingly. The monitoring API 31 determines the physical machine 22 is under abnormal states (for example CPU usage is up to 70% and longer than 5 minutes) and generates the abnormal state message when the physical machine 22 has abnormal events lasting for a predetermined time length. Thus, the management terminal 3 respectively provides different warning messages, or informs different administrators to address the issues according to the abnormal event message and the abnormal state message.

After the step S36, the management terminal 3 receives an external trigger by the administrator via the user interface 32 (step S38), generates the control signals C1 according to the trigger, and transmits the control signals C1 to the cabinet 21 with the physical machine 22 having abnormal operation states (step S40). Further, the management terminal 3 automatically generates the control instruction C1 after the abnormal event message or the abnormal state message is generated, and automatically transmits the control instruction C1 cabinet 21 with the physical machine 22 having abnormal operation states (step S42), but the application is not limited thereto. Thus, after the step S40 or S42, the cabinet 21 compulsorily ejects the physical machine 22 having abnormal operation states according to the control instruction C1, which is convenient to the administrators to locate and replace the damaged physical machine 22.

In the first embodiment, the execution efficiency of the predetermined daemon program 221 is insufficient to perform complicated computing tasks. The daemon program 221 is used for collecting and compiling statistics of the data in the physical machines 22. The analyzing and determining tasks are executed by the management terminal 3. Nonetheless, if the daemon program 221 is capable of performing complicated computing tasks, the daemon program 221 directly analyzes the operation states of the physical machine 22 for reducing the loading of the management terminal 3.

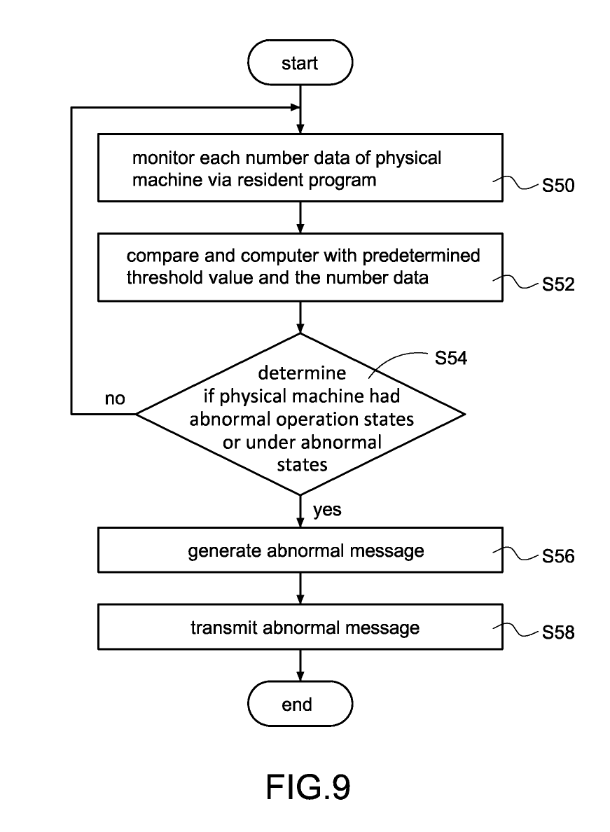

FIG. 7, FIG. 8 and FIG. 9 ire a system architecture diagram, system block diagram, and monitoring flowchart of a second preferred embodiment according to the present invention. As the embodiment shown in FIG. 8, each physical machine 22 respectively executes a daemon program 222 having higher computing capability, and, the management terminal 3 further has a message queue 33.

As shown in FIG. 9, the cabinet 21 monitors the physical machines 22 firstly starting by monitoring each number data of the physical machine 22 via the daemon program 222 (step S50), for example operation states of above mentioned CPU, memory and hard drives etc. Next, the daemon program 222 performs comparing and computing with a predetermined threshold value and the number data (step S52). The computing results determine if the physical machine 22 has abnormal operation states, and in details, determine if the physical machine 22 has abnormal events, or if the physical machine 22 is under abnormal states (step S54). If none of the physical machine 22 has abnormal operation states, the method moves back to the step S50. The daemon program 222 continuous to monitor data of the physical machine 22. If one of the physical machine 22 is determined having abnormal operation states, the daemon program 222 generates the abnormal message M1 (step S56), and transmits the abnormal message M1 (step S58).

In the embodiment, when the physical machine 22 has abnormal events (for example the CPU usage is higher than 70%), the daemon program 222 generates and transmits the abnormal event message, and generates and transmits the abnormal state message when the physical machine 22 is under abnormal states (for example the CPU usage is higher than 70% and lasting for 5 minutes). The daemon program 222 regards that the physical machine 22 is under abnormal states when the abnormal events occur and last for a predetermined time length.

As shown in FIG. 8, the management terminal 3 has the message queue 33. In the step S58, the daemon program 222 transmits the abnormal message M1 (the abnormal event message or the abnormal state message) to the management terminal 3 to queue in the message queue 33. Thus, the management terminal 3 displays the warning message via the user interface 32 to inform the administrators to address the issue.

In addition, the cloud system network may be further installed with a database 4. The database 4 is connected to the physical machines 22 and the management terminal 3 via the network system. In the step S58, the daemon program 222 transmits and saves the abnormal message M1 transmitting in the database 4. The management terminal 3 periodically connects to the database 4, for accessing the abnormal message M1 in the database 4. Nonetheless, the above description includes preferred embodiments of the present invention and the scope of the invention is not limited thereto.

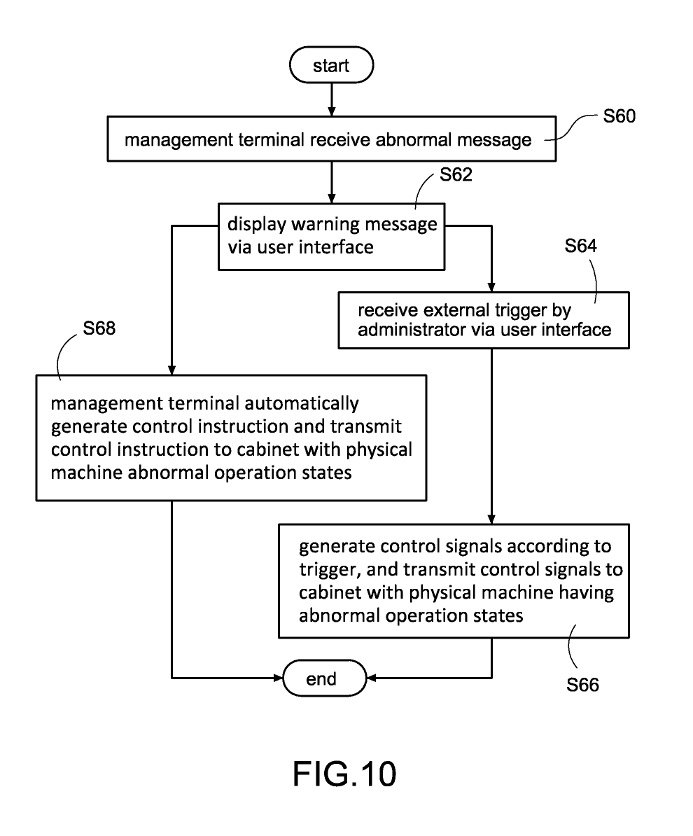

FIG. 10 is a flowchart of compulsory ejecting of a second preferred embodiment according to the present invention. When one of these physical machines 22 has abnormal operation states, the management terminal 3 receives the abnormal message M1 (step S60). In further details, the management terminal 3 retrieves the abnormal message M1 in the message queue 33, or connects to the database 4 for accessing the abnormal message M1, but is not limited thereto. The management terminal 3 receives the abnormal message M1, and displays the warning message via the user interface 32 (step S62), for keeping the administrators informed of the abnormal operation states.

In the embodiment, the management terminal 3 receives external trigger by the administrators via the user interface 32 (step S64), generates the control signals C1 according to the trigger, and transmits the control signals C1 to the cabinet 21 with the physical machine 22 having abnormal operation states (step S66). The management terminal 3 automatically generates the control instruction C1 after receiving the abnormal message M1, and automatically transmits the control instruction C1 to the cabinet 21 with the physical machine 22 having the abnormal operation states (step S68). The cabinet 21 ejects the physical machine 22 having abnormal operation states from the cabinet 21 according to the content of the control instruction C1.

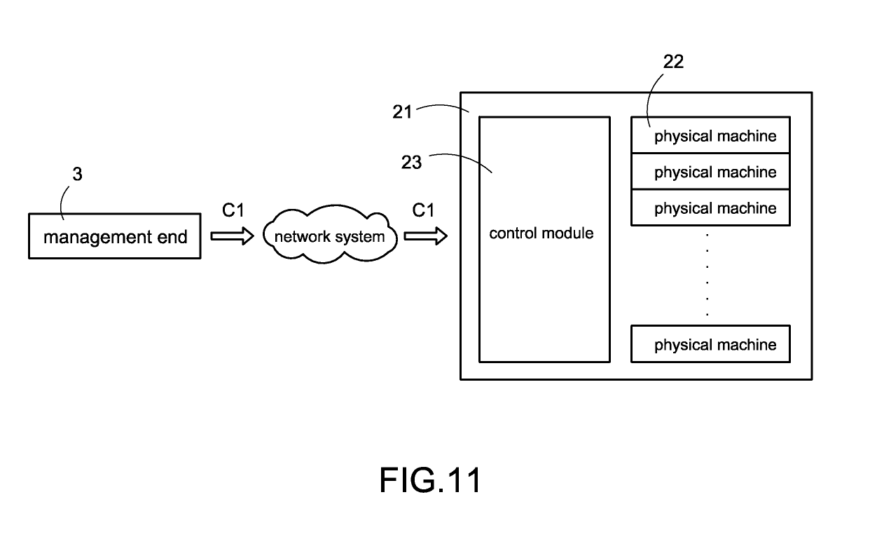

FIG. 11 is a system block diagram of a third preferred embodiment according to the present invention. As shown in the diagram, the cabinet 21 has an internal control module 23, the cabinet 21 receives the control instruction C1 provided from the management terminal 3 via the control module 23. The control module 23 ejects the physical machine 22 on the corresponding location from the cabinet 21 according to the content of the control instruction C1.

FIG. 12A and FIG. 12B are schematic diagrams before and after the physical machine is ejected from the cabinet of a preferred embodiment according to the present invention. As shown in the diagram, the cabinet 21 is respectively installed with an elastic component 212 at the back of each socket, such as a spring component, a hydraulic component, a pneumatic component, and a rubber component. A tenon 213 controlled by the control module 23 is installed in front of the socket. Each physical machine 22 is installed with a corresponding tenon receiving portion 223 on the casing. When the physical machine 22 is fitted to the socket, the tenon receiving portion 223 receives the tenon 213 and the physical machine 22 in the cabinet 21 is fixed to the socket via the tenon 213.

In the step S18, S40, S42, S66 and S68, the cabinet 21 receives the control instruction C1 via the control module 23. The control module 23 controls to move the tenon 213 on the corresponding location in the cabinet 21 according to the content of the control instruction C1 for ejecting the physical machine 22 on the corresponding location from the cabinet 21. In further details, the control module 23 controls the tenon 213 to depart the tenon receiving portion 223 on the housing of the physical machine 22, whereby the elastic component 212 at the back of the cabinet 21 pushes the physical machine 22 to eject from the socket. The above embodiments are preferred embodiments according to the present invention and are not limited thereto.

In further details, the cabinet 21 is installed with a coil circuit 214 on the corresponding location. When the control module 23 instructs to eject the physical machine 22, the coil circuit 214 is powered on to generate the magnetic force for attracting the tenon 213 (as shown in FIG. 12B). Thus, the tenon 213 departs from the tenon receiving portion 223 of the casing of the physical machine 22. Further, the elastic component 212 at the back of the cabinet 21 pushes the physical machine 22 to eject from the socket. In the embodiment, the tenon 213 is made by the materials attracted by the magnetic force. Nonetheless, the above is a preferred embodiment, and the cabinet 21 can be ejected from the physical machine 22 by other means depending on the field applications, and is not limited thereto.

As the skilled person will appreciate, various changes and modifications can be made to the described embodiments. It is intended to include all such variations, modifications and equivalents which fall within the scope of the invention, as defined in the accompanying claims.

What is claimed is:

1. A method for monitoring and handling abnormal states of physical machines in a cloud system, used among at least one management terminal and a plurality of physical machines, wherein the plurality of physical machines respectively disposed in a plurality of cabinets in a computing data center, the method for monitoring and handling abnormal states of physical machines in a cloud system including:
a) retrieving an abnormal message indicating at least one the physical machine having abnormal operation states by the management terminal;
b) generating a control instruction according to the abnormal message, and transmitting the control instruction to the cabinet having the physical machine by the management terminal;
c) receiving the control instruction at the cabinet, and ejecting the corresponding physical machine from the cabinet according to the control instruction.

2. The method for monitoring and handling abnormal states of physical machines in a cloud system of claim 1, wherein the cabinet is respectively installed with a light emitting component on the assigned location of each physical machine, and the method further including a step d: receiving the control instruction at the cabinet, and providing a warning signal by light emitting component at the corresponding location in the cabinet according to the control instruction.

3. The method for monitoring and handling abnormal states of physical machines in a cloud system of claim 1, wherein the management terminal has a internal monitor application program interface (API), and the step a including the following steps:
a1) retrieving at least one record file of all physical machines in the cloud computing data center from a sharing storage pool via the internal monitoring API at the management terminal, wherein these record files respectively record these operation states of the physical machine; and
a2) performing computing according to these record files at the management terminal, for determining if the physical machines has abnormal operation states.

4. The method for monitoring and handling abnormal states of physical machines in a cloud system of claim 3, wherein each physical machine respectively executes an internal daemon program, the following steps are further included before the step a:
a01) monitoring each number data of each physical machine at each physical machine via the internal daemon program;
a02) compiling statistics respectively of each number data at the daemon program;
a03) generating the record file according to the statistics results at the daemon program; and
a04) saving the record file in the sharing storage pool on the network at the daemon program.

5. The method for monitoring and handling abnormal states of physical machines in a cloud system of claim 3, wherein the management terminal determining if the physical machine has abnormal events, and determining if the physical machine has abnormal states, wherein the physical machine is regarded as having abnormal states when abnormal events occur continuously in the step a2, and the management terminal generates an abnormal events message when the physical machine has abnormal events, and generates an abnormal state message when the physical machine is under abnormal states.

6. The method for monitoring and handling abnormal states of physical machines in a cloud system of claim 1, wherein the management terminal further provides a user interface (UI), and the step b includes the following step:
b1) receiving external trigger at the user interface; and
b2) generating and transmitting the control signals according to the trigger.

7. The method for monitoring and handling abnormal states of physical machines in a cloud system of claim 6, wherein the method further including a step b3: display a warning message via the user interface.

8. The method for monitoring and handling abnormal states of physical machines in a cloud system of claim 1, wherein each physical machine respectively executes an internal daemon program, the following steps are further included before the step a:
a11) monitoring each number data of each physical machine at each physical machine via the internal daemon program;
a12) performing computing according to these number data and a predetermined threshold value at the daemon program;
a13) determining if the physical machine has abnormal operation states according to the computing results at the daemon program;
a14) generating the abnormal message at the daemon program if the physical machine is determined having abnormal operation states; and
a15) transmitting the abnormal message externally at the daemon program.

9. The method for monitoring and handling abnormal states of physical machines in a cloud system of claim 8, wherein the step a13 determines if the physical machine has abnormal events, and determines if the physical machine is under abnormal states, wherein when abnormal events occur continuously at the physical machine for a predetermined time length, the physical machine is regarded under abnormal states, an abnormal events message is generated and externally transmitted when the physical machine has abnormal events, and an abnormal state message is generated and externally transmitted when the physical machine is under abnormal states in the step a14 and the step a15.

10. The method for monitoring and handling abnormal states of physical machines in a cloud system of claim 8, wherein the management terminal executes at least one message queue, and the physical machine transmits the abnormal message to the management terminal via the daemon program in the step a15.

11. The method for monitoring and handling abnormal states of physical machines in a cloud system of claim 8, wherein the physical machine transmits the abnormal message to a database via the daemon program in the step a15, and the management terminal connects to the database for retrieving the abnormal message in the step a.

12. A method for monitoring and handling abnormal states of physical machines in a cloud system, used among at least one management terminal and a plurality of physical machines, wherein the plurality of physical machines respectively disposed in a plurality of cabinets in a computing data center, and each physical machine respectively executing a internal daemon program, the method for monitoring and handling abnormal states of physical machines in a cloud system including:
a) monitoring each number data of each physical machine at each physical machine via the internal daemon program;
b) performing computing according to these number data and a predetermined threshold value, and determining if the physical machine has abnormal operation states according to the computing results at the daemon program;
c) determining if the physical machine having abnormal operation states at the daemon program, and the daemon program generating an abnormal message when the physical machine is determined to have abnormal operation states;
d) transmitting externally the abnormal message to queue in a message queue in the management terminal at the daemon program;
e) generating a control instruction, and transmitting to the cabinet with the physical machine having abnormal operation states according to the abnormal message in the message queue at the management terminal; and
f) receiving the control instruction at the cabinet, and controlling to eject the physical machine having abnormal operation states from the cabinet according to the control instruction.

13. A cloud system, comprising:
a cabinet having a control module;
a management terminal connecting with the control module of the cabinet;
a plurality of physical machines respectively installed in multiple sockets of the cabinet;
wherein, the management terminal retrieving an abnormal message indicating at least one the physical machine having abnormal operation states, generating a control instruction according to the abnormal message, the cabinet receives the control instruction through the control module, and ejecting the corresponding physical machine from the cabinet according to the control instruction.

14. The cloud system of claim 13, wherein the cabinet is respectively installed with an elastic component at the back of each socket, a tenon is installed in front of each socket for fixing the physical machines, the control module receives the control instruction and controls the tenon at the corresponding socket of the cabinet to release from the physical machine according to the content of the control instruction for enabling the elastic component at the back of each socket to eject the physical machine from the cabinet.

15. The cloud system of claim 13, wherein the cabinet the cabinet is respectively installed with a light emitting component on the assigned location of each physical machine, and the control module receives the control instruction to control the light emitting component at the assigned location to send a warning signal according to the content of the control instruction.

16. The cloud system of claim 13, wherein each physical machine respectively executes an internal daemon program monitoring each number data of each physical machine and generating a record file according to the statistics results, the cloud system includes a sharing storage pool for saving the record file of each physical machine, and the management terminal has a monitor application program interface (API) retrieving the record files of all physical machines and performing computing according to the record files for determining if the physical machines has abnormal operation states.

17. The cloud system of claim 16, wherein the record file is a .rrd file and respectively comprises statistics of CPU states, memory states, hard drive states, network states, temperature states, voltage states and fan speed states of each physical machine.

18. The cloud system of claim 13, wherein each physical machine respectively executes an internal daemon program monitoring each number data of each physical machine and performing computing according to these number data and a predetermined threshold value, determining if the physical machine has abnormal operation states according to the computing results, and generating an abnormal message to transmit externally when the physical machine is determined having abnormal operation states.

19. The cloud system of claim 18, wherein the management terminal executes at least one message queue, each physical machine transmit the abnormal message to the management terminal via the daemon program and queue in the message queue.

20. The cloud system of claim 18, the cloud system further comprises a database, each physical machine transmits the abnormal messages to the database via the daemon program and the management terminal connects to the database for retrieving the abnormal messages.
